(19) United States
(12) Patent Application Publication
(10) Pub. No.: US 2021/0406138 A1
(43) Pub. Date: Dec. 30, 2021

(54) CAN TRANSCEIVER

(71) Applicant: NXP B.V., Eindhoven (NL)

(72) Inventors: Lucas Pieter Lodewijk van Dijk, Kranenburg (DE); Georg Olma, Grasbrunn (DE); Martin Wagner, Norderstedt (DE)

(21) Appl. No.: 16/913,273

(22) Filed: Jun. 26, 2020

(51) Int. Cl. G06F 11/20; H04B 1/40; G06F 13/40

(52) U.S. Cl. CPC G06F 11/2007; H04L 2012/40215; G06F 13/4086; H04B 1/40

(57) ABSTRACT

A transceiver is disclosed. The transceiver includes a first receiver line, a first transmitter line, a second receiver line, and a second transmitter line, wherein the first receiver line and the second receiver line are coupled to a receiver line selector and the first transmitter line and the second transmitter line are coupled to a transmitter line selector. A system monitor is included that is configured to monitor a controller area network (CAN) bus and the first transmitter line and to select the second transmitter line and the second receiver line if an error condition is detected through the monitoring of the first transmission line. A bias voltage generator is included to generate a bias voltage for a terminating capacitor of the CAN bus, wherein the bias voltage generator is activated by the system monitor when an error condition is detected in the CAN bus.

### BACKGROUND

A Controller Area Network (CAN bus) is a vehicle bus standard designed to allow microcontrollers and devices to communicate with each other's' applications without a host computer. It is a message-based protocol, designed originally for multiplex electrical wiring within automobiles to save on copper, but can also be used in many other contexts. For each device the data in a packet is transmitted sequentially but in such a way that if more than one device transmits at the same time the highest priority device is able to continue while the others back off. Packets are received by all devices, including by the transmitting device. The CAN bus uses a twisted wire pair in which one wire is CANH and the other CANL. For one reason or another, these wires may not be property soldered and may show intermittent open that can cause bit errors and may cause an interruption in data communication. In addition, a microcontroller that uses the CAN bus may fail and cause safety issues. One way to solve the issues with the reliability of the CAN bus and other components on the CAN bus is to provide redundancy. However, providing a parallel redundant CAN bus, transceivers, chokes that couple transceivers with the CAN bus, etc. can add cost, maintenance and complexity of the communication system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a transceiver is disclosed. The transceiver includes a first receiver line, a first transmitter line, a second receiver line, and a second transmitter line, wherein the first receiver line and the second receiver line are coupled to a receiver line selector and the first transmitter line and the second transmitter line are coupled to a transmitter line selector. A system monitor is included that is configured to monitor a controller area network (CAN) bus and the first transmitter line and to select the second transmitter line and the second receiver line if an error condition is detected through the monitoring of the first transmission line. A bias voltage generator is included to generate a bias voltage for a terminating capacitor of the CAN bus, wherein the bias voltage generator is activated by the system monitor when an error condition is detected in the CAN bus.

In some examples, the system monitor is further configured to monitor the first receiver line for the error condition and select the second transmitter line and the second receiver line through the receiver line selector and the transmitter line selector. The receiver line selector and the transmitter line selector are configured to be operated simultaneously. The transceiver may include an enable circuit that is configured to disable communication to the CAN bus, wherein the enable circuit includes two switches in series that are operated simultaneously to disconnect power to CANL pin.

In some embodiments, a voltage adjustment circuit may be included. The voltage adjustment circuit is configured to generate a biasing voltage for a terminating end of the CAN bus upon detection of an open wire in the CAN bus to allow a communication with the CAN bus using one wire. The system monitor may include a CAN bus error detector which includes a first comparator, a first resistor and a second resistor, wherein the first comparator is connected across the second resistor and an end of the first resistor is connected to CANH pin. In another example, the system monitor may include a CAN bus error detector which includes a first comparator, a first resistor and a second resistor, wherein the comparator is connected across the second resistor and an end of the first resistor is connected to CANL pin. The CAN bus error detector may include a configurable voltage source which includes a first set of resistors coupled with a first switch and a second set of resistors coupled with a second switch. The first switch and the second switch are configured to bypass one or more of the plurality of resistors based on a control signal.

In some examples, the bias voltage is 1V or 4V depending on the error condition. In some embodiments, the transceiver may include a pair of slope controller coupled together through a plurality of transistors and a plurality of diodes. The pair of slope controllers are operated by the system monitor to provide a differential voltage to CANH and CANL pins.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Advantages of the subject matter claimed will become apparent to those skilled in the art upon reading this description in conjunction with the accompanying drawings, in which like reference numerals have been used to designate like elements, and in which:

FIG. 1 depicts a controller area network (CAN) bus with a terminating end capacitor in accordance with one or more embodiments of the present disclosure;

FIG. 2 depicts CAN bus communication protocol showing a representation of “0” and “1” based on a differential voltage at CANH and CANL;

FIG. 3 shows a transceiver in accordance with one or more embodiments of the present disclosure;

FIG. 4 shows a schematic of a circuit for adjusting a voltage at the terminating capacitor of CAN bus in accordance with one or more embodiments of the present disclosure;

FIG. 5 shows a schematic of a circuit for generating a variable voltage at the terminating capacitor of CAN bus to overcome intermittent open CANH or CANL wire in accordance with one or more embodiments of the present disclosure.

FIG. 6 shows a schematic of a circuit for generating a variable voltage to be applied at CANH or CANL to overcome intermittent open CANH or CANL wire in accordance with one or more embodiments of the present disclosure;

FIG. 7 shows an example implementation of an transmission enable module in accordance with one or more embodiments of the present disclosure; and

FIG. 8 shows a transceiver in accordance with one or more embodiments of the present disclosure; and

FIG. 9 depicts a CAN bus with a transceiver of FIG. 2 in accordance with one or more embodiments of the present disclosure.

Note that figures are not drawn to scale. Not all components in the transceiver chip are shown. The omitted components are known to a person skilled in the art.

### DETAILED DESCRIPTION

Many well-known manufacturing steps, components, and connectors have been omitted or not described in details in the description so as not to obfuscate the present disclosure.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, “one example”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

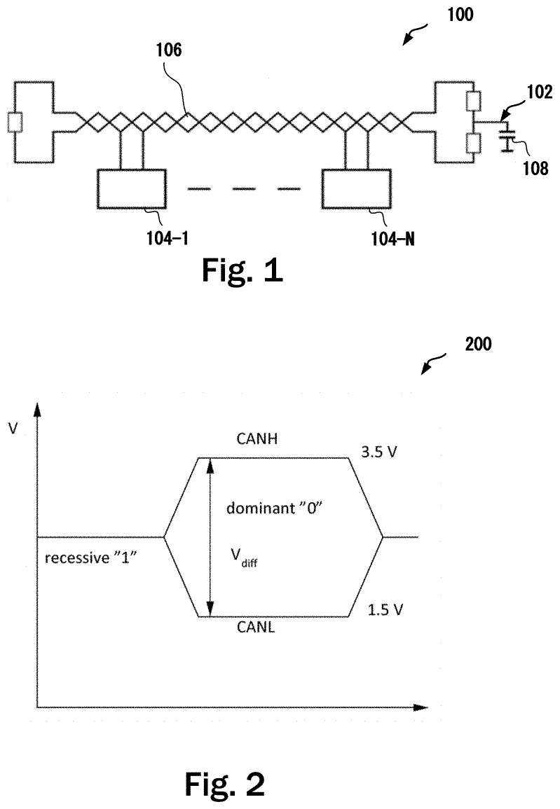

FIG. 1 depicts a controller area network (CAN) bus 100 with a terminating end capacitor 108. The CAN bus 100 includes a twisted wire pair 106. The twisted wire pair 106 includes CANH and CANL wires. The CAN bus 100 may include one or more communication nodes 104-1 . . . 104-N. The capacitor 108 is typically 4.7 nF. The value of the capacitor 108 may be increased to approximately 100 nF. By increasing the value of the capacitor 108, a signal voltage at CANL or CANH during intermittent opens is improved. However, the improvement in the signal voltage is not sufficient to have a reliable communication during intermittent opens. The resistors coupled with the capacitor 108 are typically 60 ohm each.

As shown, the communication nodes (ECUs) 104-1 . . . 104-N are connected via an unshielded twisted pair 106. Termination is implemented at the far left- and right-hand side of the CAN bus 100. There are two options, either by using a single resistor as shown in the left-hand side of the CAN bus 100, or via two resistors and the capacitor 108, referred to as “split-termination” as shown on the right-hand side of the CAN bus 100. The latter method is commonly used as it offers an additional low-pass filtering to improve EMC performance.

As shown in FIG. 2, in normal operation (when no errors are present) the CAN bus 100 signals CANH and CANL are driven such that a differential voltage is generated (to send a dominant signal) or no differential signal is generated (to send a recessive bit). For a dominant bit (“0”) the voltage at CANL is approximately 1.5V and the voltage at CANH is 3.5V and Vdiff represents a difference between the voltages at CANH and CANL.

In some examples, the following error conditions may cause disruption in the communication on the CAN bus 100.
1. Open wire on CANH or CANL
2. Intermittent open wire on CANH or CANL
3. Open connection contact at CANH or CANL
4. Intermittent open connection contact at CANH or CANL
5. Open Solder joint contact at CANH or CANL
6. Intermittent open solder joint contact at CANH or CANL
7. Open Solder joint contact at TXDL or RXDL at microcontroller
8. Intermittent open Solder joint contact at TXDL or RXDL at microcontroller
9. Open Solder joint contact at TXDL or RXDL at transceiver
10. Intermittent open Solder joint contact at TXDL or RXDL at transceiver
11. When a common-mode choke is used, there are also associated errors possible with that (e.g. solder joint related).

A typical solution that uses a larger capacitor 108 has drawbacks. The bitrate is limited to 125 kbit/s. The solution needs external 511Ω (connected between RtL-pin of a CAN transceiver and CANL and between the RtH-pin of the CAN transceiver and CANH) at the terminating end. This solution does not allow for the “standardized” CAN transceiver pinout. The internal switches on RtH and RtL pins need to be implemented with high-voltage transistors such that the typical solution will require larger area on the silicon wafer for the CAN transceiver. Note that CAN transceivers are parts of the nodes 104-1 . . . 104-N. A CAN transceiver (not shown) interfaces between a CAN protocol controller (not shown) and the physical wires 106 of the CAN bus 100. CAN transceivers and CAN protocol controller is well known in the art.

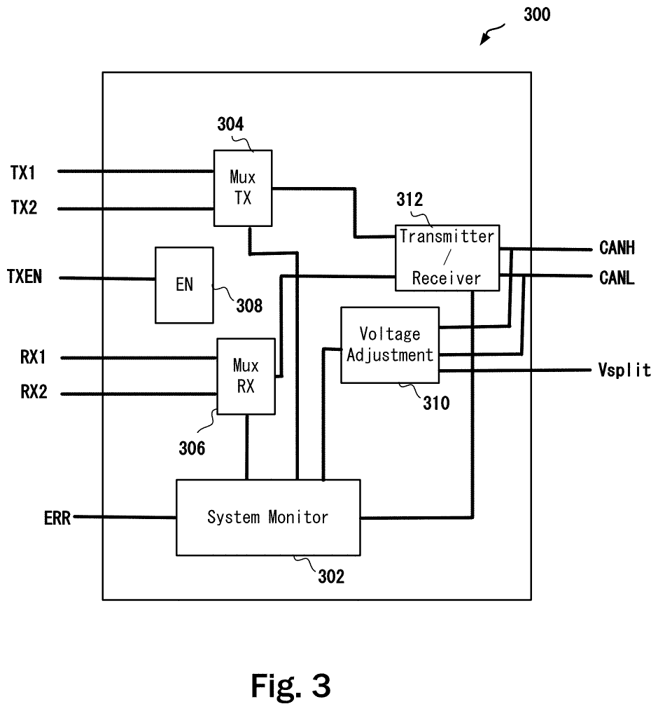

FIG. 3 shows a CAN transceiver 300. The CAN transceiver 300 includes features to provide redundancy in terms of failure of CANL and CANH wires or failure in microcontrollers or a failure in communication between a microcontroller and the transceiver 300 or other bus conditions that may potentially cause or indicative of error conditions.

U.S. application Ser. No. 16/693,022 filed on Nov. 22, 2019 by the present inventor and entitled “CAN COMMUNICATION WITH BROKEN CABLE” describes adjusting bus split voltage, which is being incorporated herein by reference in its entirety. U.S. application Ser. No. 16/509,304 filed on Jul. 11, 2019 by the present inventor and entitled “COMMUNICATION BETWEEN TRANSCEIVER AND MICROCONTROLLER” describes two way communication between a microcontroller and a transceiver, which is being incorporated by reference in its entirety.

The transceiver 300 includes two transmitter pins TX1, TX2 and two receiver pins RX1, RX2. In some example, two microcontrollers or ECUs may be coupled with the transceiver 300 to provide redundancy in case of a microcontroller failure. For example, TX1 may be connected to Microcontroller 1 and TX2 may be connected to Microcontroller 2. Both microcontrollers may be coupled to two different subsystems (e.g., a braking control system) to provide a redundancy. This redundancy provides a better safety that is desirable in modern vehicles, especially with autonomous driving features. In some embodiments, the transceiver 300 may also support more than two microcontrollers.

The transceiver 300 includes a system monitor 302 that is configured to monitor TX1, TX2, RX1, RX2 lines. The system monitor 302 also monitors CANL and CANH lines to monitor voltages, for example. The system monitor 302 may also monitor temperature, safety and security related events on the CAN Bus 106. For example, the system monitor 302 may check if the communication on transmitter and receiver lines is compliant with CAN protocol. For example, the system monitor 302 may check the voltage levels and if the voltage levels are outside the a predefined thresholds and switch over to the second set of transmitter and receiver lines. The transceiver 300 may include ERR pin coupled the system monitor 302 to provide an error signal to an external entity such as a microcontroller (not shown) coupled with the transceiver 300. TX1, TX2 lines may be coupled with a line selector (Mux TX) 304. The system monitor 302 may continuously monitor TX1 line for example and if it detects a failure in communication on TX1, the system monitor 302 may select TX2 line. In some examples, the system monitor 302 may also select RX2 line simultaneous to the selecting of TX2. The transmission failure may be detected by monitoring the voltage levels on TX1 and verifying data frames on TX1. When a switch over to TX2 occurs, the ERR signal may be activated so than an external (i.e., external to the transceiver 300) monitoring system may inform the operator of a vehicle, for example. In some example, a driving control system may steer the vehicle to a safe location for safety reasons. The redundancy feature provided by the transceiver 300 will continue to ensure a normal or controllable operation until the redundant component also fails. However, in some examples, the time interval between the failure of the first microcontroller and the second microcontroller may be sufficient to steer the vehicle to safety. A receiver line selector (Mux RX) 306 is included to switch between the first microcontroller and the second microcontroller. The Mux TX 304 and Mux RX 306 may be operated by the system monitor 302 in synchronization, that is, if TX2 is selected, RX2 is also selected. In some embodiments, the receiver line selector 306 and the transmitter line selector 304 may be implemented using toggle switches that may be operated using a same drive signal to toggle both switches simultaneously to switch from Microcontroller 1 to Microcontroller 2.

The transceiver 300 includes a transmitter and a receiver 312 that are coupled with CANL and CANH lines. The transmitter and the receiver are shown in a same box in FIG. 2 for simplicity purposes. In some example, the transmitter and the receiver may be separately fabricated on a chip. The system monitor 302 may be coupled with the transmitter/receiver 312 to monitor the communication and also the voltage levels at CANH, CANL to identify any broken wire of error conditions in the reception or transmission of data. A voltage adjustment circuit 310 may be included to generate Vsplit voltage based on the monitoring of CANH and CANL lines to ensure a communication, at least for time being with some degradation, in case of an open CANL or CANH wire. A transmission enable circuit 308 may be provided to reliably stop transmission when a safety condition requires so.

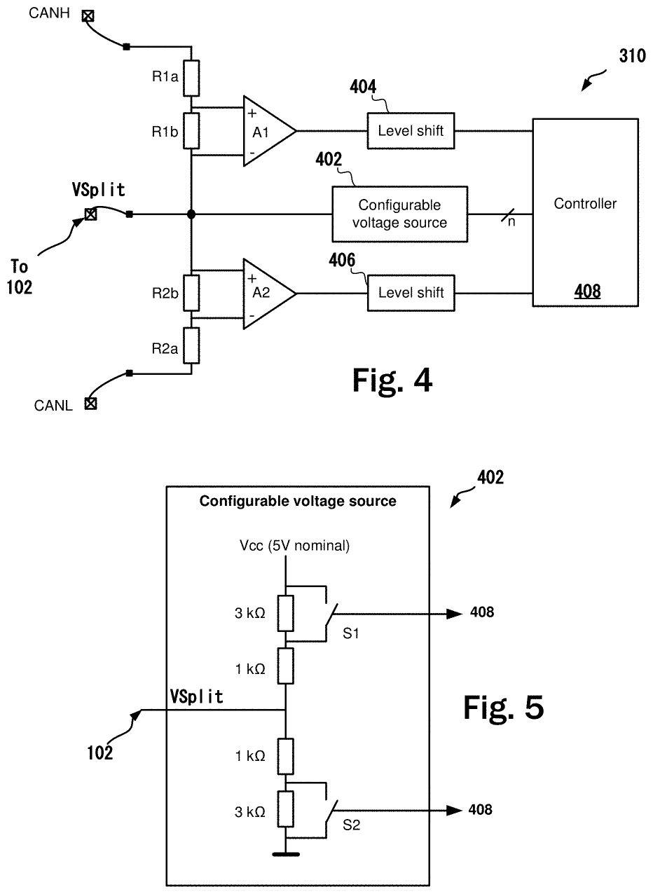

FIG. 4 shows a sample implementation of a voltage adjustment circuit 310 for generating a bias voltage to overcome error conditions on CANH or CANL. The bias voltage is applied to the capacitor 108. The voltage adjustment circuit 310 includes a resistor R1a coupled to CANH and a resistor R1b. The resistors R1a and R1b are coupled with a comparator A1. An optional level shifter 404 may be included to change the voltage domain of the voltage at the output of the comparator A1. The voltage adjustment circuit 310 further includes resistors R2b and R2a that are coupled with a comparator A2. An optional level shifter 406 may be included to change the voltage domain of the voltage at the output of the comparator A2. A configurable voltage source 402 is included to adjust the voltage at the terminal of the capacitor 108.

The resistors R2b and R1b allow current sense in CANL and CANH branch respectively. The sensed current is converted via differential amplifiers A1 and A2 to a voltage. When the sensed current in the CANH branch (detected via the comparator A1) is zero but the sensed current in the CANL branch (detected via the comparator A2) is not zero, an open CANH connection is detected and the configurable voltage source 402 is configured to produce, in one example, 4V. Similarly, when the sensed current in the CANL branch (detected via the comparator A2) is zero but the sensed current in the CANH branch (detected via the comparator A1) is not zero, an open CANL connection is detected and the configurable voltage source 402 is configured to produce, in one example, 1V. In other cases the configurable voltage source 402 is biased to 2.5 V (Vcc/2 equivalent to half the supply voltage). A controller 408 is included to send control signals to the configurable voltage source 402 based on the sensed current in the CANH and CANL branches as described above.

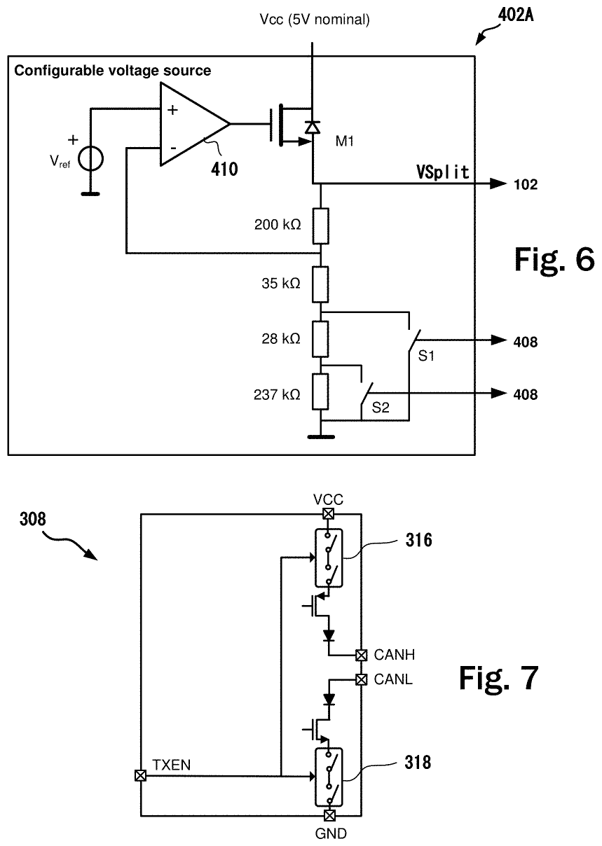

Various implementations are possible for the configurable voltage source 402. FIG. 5 and FIG. 6 show two such example implementations. FIG. 5 shows a configurable voltage source 402 using a resistive divider. When the switch S1 and the switch S2 are both opened, the split voltage VSplit (that is applied to the terminal 102 of the capacitor 108) is set to 2.5V (Vcc divided by two). When the switch S1 is closed (and the switch S2 opened) the split voltage VSplit is set to 4V and when the switch S2 is closed (and the switch S1 opened) the split voltage VSplit is set to 1V. The switches S1 and S2 are opened or closed based on a control signal from the controller 408.

FIG. 6 shows the configurable voltage source 402 in another embodiment 402A. In this embodiment, the configurable voltage source 402A includes a comparator 410 coupled with the reference voltage Vref and the comparator 410 is configured to drive a transistor M1. The switches S1 and S2 are controlled by a control signal from the controller 408. The configurable voltage source 402A operates based on a linear voltage regulator where the voltage feedback ladder is configured differently depending on the required nominal output voltage. The split voltage (VSplit) is set to 1V when both the switches S1 and S2 are opened. VSplit is set to 4 V when the switch S1 is closed and the switch S2 is opened. Vsplit can also be set to 2.5 V when the switch S2 is closed and the switch S1 is opened. It is noted that the reference voltage (Vref, equal to 0.6 V in the example embodiment) is a well-known Bandgap voltage reference but could alternatively be realized by a resistive divider connected to Vcc such that the output voltage would also track the supply voltage Vcc.

FIG. 7 shows an example implementation of the EN module 308. The TXEN signal is used from an entity that is external to the transceiver 300 to enable or disable the transmission via the transceiver 300. During some security events it is important that the transmission of signals to the CAN bus 106 from the transceiver 300 is reliably stopped. The sample implementation uses a group of CANH switches 316 and a group of CANL switches 318. The groups of switches 316, 318 may include a plurality of individual switches in series. In some examples, the use of only one switch may not completely stop the transmission due to the switch failure (for example).

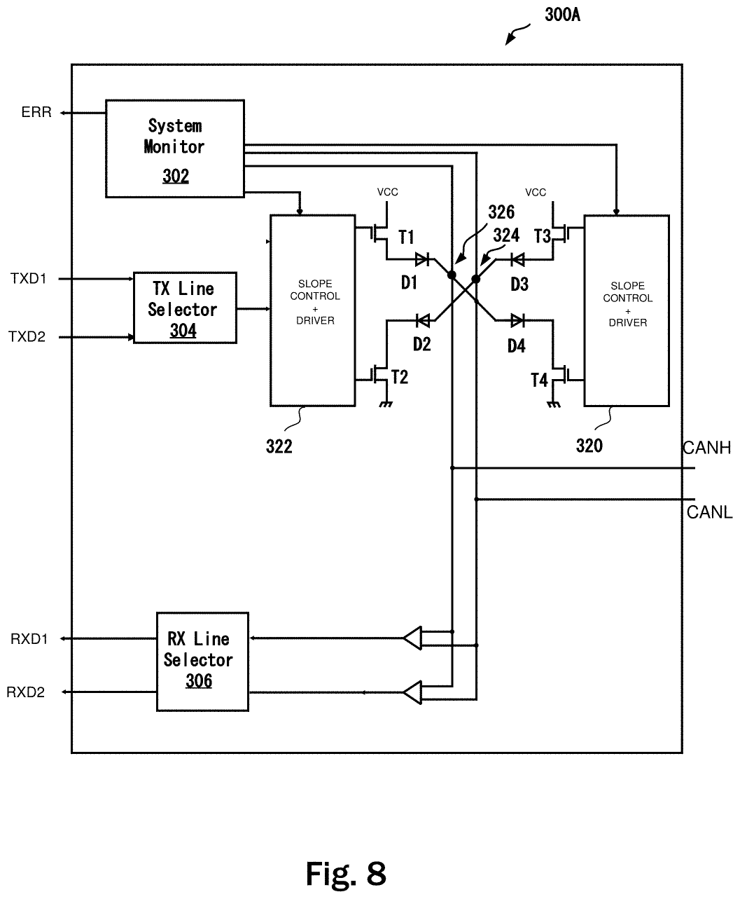

FIG. 8 shows a transceiver 300A. As apparent, not all components are being shown in FIG. 8 so as not to obfuscate the present disclosure. The transceiver 300A includes transistors T1, T2, T3, T4 and diodes D1, D2, D3, D4 coupled to a first slope controller 320 and a second slope controller 322. The slope controllers and the associated circuit arrangement including the transistors and the diode is used to provide CANL, CANH differential signal. The system monitor 302 may be coupled with the slope control circuit arrangement at joins 324 and 326. If the system monitor 302 detects an open CANH or open CANL, the system monitor 302 may provide voltage at the joins 324 or 326 such that even one wire has sufficient voltage swing to enable a communication via one wire. In some examples, the voltage swing is provided to CANL/CANH along with providing a bias voltage Vsplit to the capacitor 108, as described earlier.

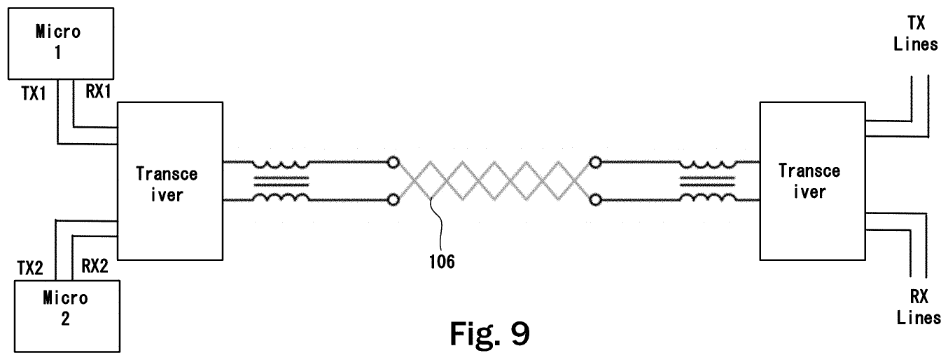

FIG. 9 shows the CAN bus 106 in which the transceiver 300 is used. As shown, the transceiver 300 includes two RX lines and two TX lines to coupled with two ECUs or microcontrollers to provide a redundancy.

Some or all of these embodiments may be combined, some may be omitted altogether, and additional process steps can be added while still achieving the products described herein. Thus, the subject matter described herein can be embodied in many different variations, and all such variations are contemplated to be within the scope of what is claimed.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A transceiver, comprising:
a first receiver line, a first transmitter line, a second receiver line, and a second transmitter line, wherein the first receiver line and the second receiver line are coupled to a receiver line selector and the first transmitter line and the second transmitter line are coupled to a transmitter line selector;
a system monitor configured to monitor a controller area network (CAN) bus and the first transmitter line and to select the second transmitter line and the second receiver line if an error condition is detected through the monitoring of the first transmission line; and
a bias voltage generator to generate a bias voltage for a terminating capacitor of the CAN bus, wherein the bias voltage generator is activated by the system monitor when an error condition is detected in the CAN bus.

2. The transceiver of claim 1, wherein the system monitor is further configured to monitor the first receiver line for the error condition and select the second transmitter line and the second receiver line through the receiver line selector and the transmitter line selector.

3. The transceiver of claim 1, wherein the receiver line selector and the transmitter line selector are configured to be operated simultaneously.

4. The transceiver of claim 1, further including an enable circuit that is configured to disable communication to the CAN bus, wherein the enable circuit includes two switches in series that are operated simultaneously to disconnect power to CANL pin.

5. The transceiver of claim 1, further a voltage adjustment circuit that is configured to generate a biasing voltage for a terminating end of the CAN bus upon detection of an open wire in the CAN bus to allow a communication with the CAN bus using one wire.

6. The transceiver of claim 1, wherein the system monitor includes a CAN bus error detector which includes a first comparator, a first resistor and a second resistor, wherein the first comparator is connected across the second resistor and an end of the first resistor is connected to CANH pin.

7. The transceiver of claim 1, wherein the system monitor includes a CAN bus error detector which includes a first comparator, a first resistor and a second resistor, wherein the comparator is connected across the second resistor and an end of the first resistor is connected to CANL pin.

8. The transceiver of claim 6, wherein the CAN bus error detector including a configurable voltage source which includes a first set of resistors coupled with a first switch and a second set of resistors coupled with a second switch.

9. The transceiver of claim 8, wherein the first switch and the second switch are configured to bypass one or more of the plurality of resistors based on a control signal.

10. The transceiver of claim 1, wherein the bias voltage is 1V or 4V depending on the error condition.

11. The transceiver of claim 1, further including a pair of slope controller coupled together through a plurality of transistors and a plurality of diodes.

12. The transceiver of claim 11, wherein the pair of slope controllers are operated by the system monitor to provide a differential voltage to CANH and CANL pins.
